(19) United States
(12) Patent Application Publication
(10) Pub. No.: US 2007/0220675 A1
(43) Pub. Date: Sep. 27, 2007

(54) Filtration-based system and method for prevention of separation anxiety

(76) Inventors: Richard Haskins, Los Angeles, CA (US); Mindy E. Rothstein, Los Angeles, CA (US)

Correspondence Address: Elliott N. Kramsky, Esq., Suite 400, 5850 Canoga Avenue, Woodland Hills, CA, 91367, US

(21) Appl. No.: 11/385,281

(22) Filed: Mar. 22, 2006

(51) Int. Cl. A47G 9/02; A47G 9/00

(52) U.S. Cl. 5/485; 5/482; 5/655; 5/641

(57) ABSTRACT

A system and method for the transfer of an absent human's distinctive scent to a remote dependent. A pad, which acts as the transfer medium, is worn by the human to absorb its distinctive pheromones and odors. The pad is thereafter inserted into a pocket provided within a blanket. The blanket comprises fabric that includes fibers embedded with activated carbon for adsorbing undesired scent-masking odors.

### BACKGROUND

1. Field of the Invention

The present invention relates to the bonding process that is applicable to both (human) mother-infant and (human) owner-pet interactions. More particularly, this invention pertains to a system and method for transferring the comforting presence of the scent of a familiar, though absent, human being to proximity to either an infant child or a devoted pet to minimize the effects of separation anxiety.

2. Description of the Prior Art

Separation anxiety is recognized as a major influence in infant (i.e. up to approximately 3 months) development. It is understood that it can even affect long term mental health.

Even the most devoted mother must separate physically from her infant at times to address her own needs and to permit the child to sleep, etc. Dealing with separation anxiety becomes a particularly vexing issue for the single or working mother of today who may be confronted with numerous non-traditional responsibilities during the critical period of early childhood development.

This phenomenon is also recognized to afflict human-pet nurturing.

### SUMMARY OF THE INVENTION

The present invention addresses the preceding and other shortcomings of the prior art by providing, in a first aspect, a system for delivering the scent of an absent human to a dependent. Such system includes a blanket and a pad of scent-absorbent material. A pocket element is fixed to the blanket for receiving the pad. The blanket is of woven activated carbon-based odor-adsorbent fabric.

In a second aspect, the invention provides a bonding method. The method is begun by providing a blanket comprising odor-adsorbent activated carbon based fibers that includes a pocket, and at least one pad of scent-absorbent material.

The pad is contacted to the mother's body for a predetermined amount of time sufficient to absorb a human's scent. Thereafter, the pad is inserted into the pocket and a dependent then wrapped in the blanket so that the dependent is able to inhale the scent absorbed into the pad.

The foregoing and other features of the invention will become further apparent from the detailed description that follows. Such description is accompanied by a set of drawing figures. Numerals of the drawing figures, corresponding to those of the written description, point to the features of the invention with like numerals referring to like features throughout both the written description and the drawing figures.

### BRIEF DESCRIPTION OF THE DRAWINGS

FIGS. 1(a) through 1(c) are a plan view of the blanket and plan and side elevation views of the pad respectively comprising an infant bonding system in accordance with, and for practicing the method of invention; and

FIGS. 2(a) through (c) a comprise a series of views for illustrating the process for transferring a human's scent to a blanket in accordance with an embodiment of the invention.

### DETAILED DESCRIPTION OF THE PREFERRED EMBODIMENT

The present invention relies upon the concept that separation anxiety is minimized by embedding a mother's unique scent(s) into an infant's swaddling blanket. Such scent(s) comprise both odors (scents detected consciously through the body's olfactory system) and pheromones (scents detected subconsciously through the body's vomeronasal system and designed to convey information to and from others to trigger a response). Detection of the mother's odor and pheromones by the infant is comforting in the mother's absence.

Like processes affect the bond that is recognized to exist between a human and his or her non-human pet. In fact, due to the often significantly greater development of the sense of smell in an animal, such as a dog, pheromone detection often plays a very significant function in training and domestication. Due to the crossover that exists between human-pet and human-human (mother-infanty physiological interactions, it will be understood that the invention to be described is application to both of such relationships, which are hereafter identified generically as “human-dependent” relationships.

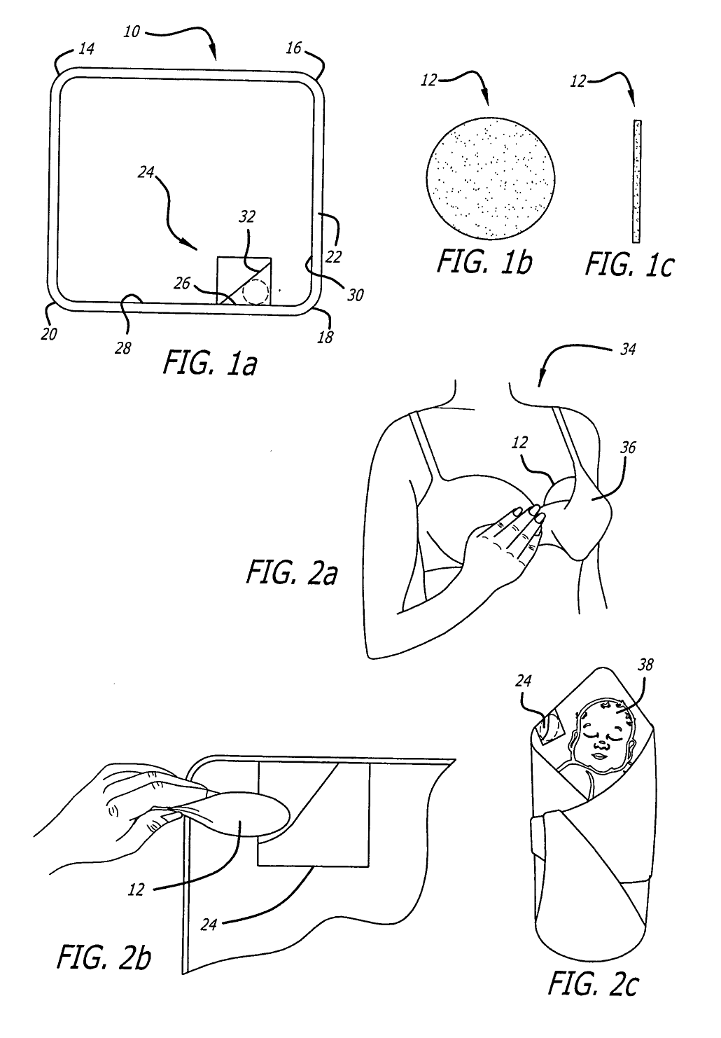

The elements of a system for delivery of a human's scent are illustrated in FIGS. 1(a) through 1(c). They include a blanket 10 (illustrated in plan view in FIG. 1(a)) and a pad 12 (illustrated in plan and side elevation views in FIGS. 1(b) and 1(c) respectively). The sheetlike pad 12 preferably serves as the medium for transferring the bonding scent from human to dependent. It comprises, for example, non-woven organic cotton or other material conducive to the retention of the human's scent molecules. As a consequence of its receptivity to scent-related molecules, the pad 12 is a disposable item that should be replaced after, at most, two days use in the blanket 10.

The blanket 10 is preferably of square shape (to facilitate the weaving process) formed of one or two layers of material that may have a variety of printed designs or finishes. It may have a number of dimensions (e.g. 68 by 68 inches) and preferably includes rounded corners 14 through 20 although the dimensions and shape of the blanket 10 may vary within the scope of the invention. The edges of the blanket 10 may be finished with rib knit 22, preferably of cotton, or like binding sewn to the peripheral edge of the blanket 10.

The blanket 10 includes a pocket 24 for receiving the pad 12. Such pocket 24 is formed by sewing a properly-sized piece of material to the blanket 10 so that an edge 26 of the pouch 24 coincides with a peripheral edge 28 of the blanket 10 and the pouch 24 is located a predetermined distance (e.g. 6 inches) from the nearest adjacent edge 30 of the blanket 10.

The material forming the pouch 24 is generally shaped as a right triangle with a hypotenuse edge 32 unstitched to the blanket 10 to thereby provide a location for insertion of the pad 12 (shown in shadow outline). As can be seen, the pad 24 is of sufficient size to enclose the pad 12 fully upon transfer from the mother (discussed below).

The blanket 10 (including the pouch 24) is of an odor-adsorbent fabric. As discussed above, the invention is based upon the transfer of a human's pheromone molecules to proximity to a dependent. Maximum benefit is obtained when the scent resulting from the molecules captured by the transfer medium (i.e. the pad 12) need not “compete” with other odors (arising from the presence of bacteria or otherwise absorbed into the blanket 10).

The material of the blanket 10 includes fibers that incorporate activated carbon derived from coconut shells. Such fibers are marketed under the trademark TRAPTEK™ by Traptek, LLC of Longmont, Colo. The activated carbon embedded within the TRAPTEK fibers adsorbs a wide range of odor molecules by a process whereby odors emanated from, for example, the dependent or inherent in the fabric and present in the surrounding environment are attracted to and trapped within the pores of the carbon. The odor molecules are released and the carbon is renewed upon washing and drying the fabric.

A presently-preferred yarn for weaving the blanket 10 comprises a blend of 60 percent cotton and 40 percent TRAPTEK® fibers. By blending the odor-adsorbent fibers of TRAPTEK® with cotton, one obtains a woven fabric having a natural feel that is particularly important for applications wherein the dependent is an infant with tender skin.

The method of the invention is illustrated for the case of a mother-infant relationship by the series of FIGS. 2(a) through 2(c). The benefits of odor recognition are studied and disclosed, for example, in the article of Rattaz, Goubert and Bullinger, “The Calming Effect of a Familiar Odor on Full-Term Newborns”, Journal of Developmental & Behavioral Pediatrics, vol. 26, no. 2 (April 2005), pgs. 86 through 92.

In FIG. 2(a) a mother 34 inserts the pad 12 under her bra 36. It is left the for a sufficient period of time to allow the pad 12 to absorb the mother's pheromones and scents. This will preferable occur prior to separation of mother from infant. Thereafter, as shown in FIG. 2(b), the pad 12, having been removed from contact with the mother's body (for optimum absorption of pheromones, the pad 12 may contact the mother anywhere within the region bounded by her bosom and navel), it is then inserted into the pocket 24 of the blanket 10. Finally, as shown in FIG. 2(c), the baby 38 is wrapped in the blanket 10 in such a way that his or her nose is in close proximity to the pocket 24 with pad 12 inserted therein.

For the case of a dependent other than an infant human being, scent absorption may occur, for example, by placing the pad 12 under a cap. This is particularly effective in a master-pet relationship where the master is either bald or balding. Thereafter, the pet is comforted when wrapped in the blanket 10 in a manner corresponding to that of an infant as illustrated in FIG. 2(c).

Thus it is seen that the present invention provides a blanket and method for reducing separation anxiety, and thereby improving the nurturing of infants and pet care. By providing a blanket that places the scent of an absent human within a dependent's blanket, the bonding process continues and the infant (or pet) is never truly remote its mother (or master). The reduction of separation anxiety is believed to contribute to the long term mental well being of a child and to render a pet more manageable in the absence of its owner.

While the invention has been described with reference to its presently preferred embodiment, it is not limited thereto. Rather, it is limited only insofar as it is defined by the following set of patent claims and includes within its scope all equivalents thereof.

What is claimed is:

1. A system for delivering a the scent of an absent human to a dependent comprising, in combination:
a) a blanket;
b) a pad of scent-absorbent material;
c) a pocket element for receiving said pad being fixed to said blanket; and
d) said blanket comprising woven activated carbon-based odor adsorbent fabric.

2. A system as defined in claim 1 wherein said woven antimicrobial fabric comprises a blend of cotton and odor adsorbent fibers.

3. A system as defined in claim 2 wherein said blend comprises 60 percent cotton and 40 percent odor adsorbent fibers.

4. A system as defined in claim 2 wherein said odor adsorbent fibers comprise TRAPTEK®.

5. A system as defined in claim 1 wherein said pocket comprises a generally-triangular piece of fabric sewn onto said blanket.

6. A system as defined in claim 2 wherein said piece of fabric forms a right triangle.

7. A system as defined in claim 6 wherein one side forming said right angle is coincident with an edge of said blanket.

8. A system as defined in claim 2 wherein said blanket is generally of square shape.

9. A system as defined in claim 1 wherein said pad comprises non-woven organic cotton.

10. A bonding method comprising the steps of:
a) providing a blanket, comprising woven activated carbon-based odor adsorbent fibers, having a pocket for receiving a pad of odor-absorbent material; then
b) contacting said pad to a human's body for a predetermined amount of time to thereby absorb said human's scent; then
c) inserting said pad into said pocket; and then
d) wrapping a dependent in said blanket so that said dependent is positioned to inhale said scent absorbed into said pad.

11. A bonding method as defined in claim 10 wherein said odor-adsorbent fibers comprise TRAPTEK®.

12. A bonding method as defined in claim 10 wherein said dependent is an infant.

13. A bonding method as defined in claim 10 wherein said dependent is a pet.
